(19) United States
(12) Patent Application Publication
(10) Pub. No.: US 2010/0039686 A1
(43) Pub. Date: Feb. 18, 2010

(54) HOLOGRAM PATTERN GENERATION METHOD AND MULTIPLE LIGHT POINTS GENERATION APPARATUS

(75) Inventors: Seiji Nishiwaki, Hyogo (JP); Kazuo Momoo, Osaka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/526,671

(22) PCT Filed: Feb. 6, 2008
(86) PCT No.: PCT/JP2008/000162

§ 371 Date: Aug. 11, 2009

(30) Foreign Application Priority Data
Feb. 16, 2007 (JP) 2007-036078

(51) Int. Cl. G03H 1/08; G03H 1/12

(52) U.S. Cl. 359/9; 359/11

(57) ABSTRACT

In order to change the number of light points and light intensities and to move positions of the light points in a real-time manner, an extremely large capacity of a memory is required. In a method according to the present invention, a memory (6) has previously stored therein data indicating a complex amplitude distribution of rays of incident light (L) on a hologram plate (4) and complex amplitude distributions on the hologram plate (4) in a case where the rays are beamed at respective points at which the rays can be beamed. The controller (5) calculates the complex amplitude distribution to be generated on the hologram plate (4) in order to generate a hologram pattern by respectively multiplying, by values indicating degrees of amplitudes of respective rays, complex amplitude distributions of rays of incident light (L) and m light points P1 through Pm to be displayed, and by calculating a sum of the values obtained by the multiplication through performing addition. The controller (5) controls the hologram plate (4) so as to configure a diffraction grating pattern corresponding to the calculated complex amplitude distribution.

### TECHNICAL FIELD

The present invention relates to a method for generating a pattern on a hologram element and to a multiple light points generation apparatus operable to beam rays of light emitted from a light source at multiple points.

### BACKGROUND ART

As a conventional technology relating to a hologram, for example, non-patent document 1 has been known. Hereinafter, based on this precedent, basic principles of recording and reproducing of the hologram will be described with reference to FIG. 6A through FIG. 9.

FIG. 6A is a schematic diagram illustrating a principle of recording a hologram according to a first method described in the non-patent document 1. FIG. 6B is a schematic diagram illustrating a principle of reproducing the hologram according to the first method.

As shown in FIG. 6A, upon recording the hologram, a transparent flat plate 3 is prepared having a surface 3S on which a photosensitive film such as a resist, a silver salt, or the like is formed, and the photosensitive film is irradiated with reference light L1 and incident light L2 from an object. These rays of the reference light L1 and the incident light L2 interfere with each other on the photosensitive film and interference fringes 3a are formed, thereby exposing the photosensitive film to light. Thereafter, by developing the photosensitive film, a grating 3b whose structure has projections and depressions is formed on the surface 3S, the grating 3b being similar to a light intensity pattern of the interference fringes 3a. Upon reproducing the hologram, as shown in FIG. 6B, by irradiating with the reference light L1 the transparent flat plate 3 which has been developed, the reference light 1 is diffracted by the grating 3b, and diffracted light L2′ (that is, the same image as that produced by the incident light L2) traveling in exactly the same direction in which the incident light 2 travels is generated.

Shown in FIG. 7A and FIG. 7B is a second method which can be easily analogized from the above-described method and is obtained by further improving the above-described method.

FIG. 7A is a schematic diagram illustrating a principle of recording a hologram according to a second method. FIG. 7B is a schematic diagram illustrating a principle of reproducing the hologram according to the second method.

Upon recording the hologram, a transparent flat plate 3 is prepared having a surface 3S on which a photosensitive film such as a resist, a silver salt, or the like is formed, and the photosensitive film is irradiated with reference light L1 as well as incident light L2a and incident light L2b in two directions from an object. These rays of the reference light L1 as well as the incident light L2a and the incident light L2b interfere with one another on the photosensitive film and interference fringes 3a are formed, thereby exposing the photosensitive film to light. Thereafter, by developing the photosensitive film, a grating 3b whose structure has projections and depressions is formed on the surface 3S, the grating 3b being similar to a light intensity pattern of the interference fringes 3a. Upon reproducing the hologram, as shown in FIG. 7B, by irradiating with the reference light L1 the transparent flat plate 3 which has been developed, the reference light L1 is diffracted by the grating 3b, and diffracted light L2a′ traveling in exactly the same direction in which the incident light L2a travels and diffracted light L2b′ traveling in exactly the same direction in which the incident light L2b are generated.

As described above, whereas one image is recorded and reproduced in the first method based on the non-patent document 1, two images can be recorded and reproduced in the second method. Here, in accordance with the same principle as that of the second method, three or more images can also be reproduced.

Furthermore, in accordance with the above-described two methods, a third method shown in FIG. 8 and FIG. 9 can be considered.

FIG. 8 is a schematic diagram illustrating a principle of reproducing a hologram according to the third method. FIG. 9 is a schematic diagram illustrating a configuration of a hologram plate 4 shown in FIG. 8.

Included inside the hologram plate 4 is a liquid crystal layer sandwiched between two substrates on which electrodes are formed. Whereas one transparent electrode (not shown) abutting the liquid crystal layer is integrally formed on a whole surface of the liquid crystal layer, the other transparent electrode 4L includes a plurality of electrodes arranged in a checkerboard-like manner. Accordingly, as shown in FIG. 9, a plurality of regions (hereinafter, referred to as “cells”) to which voltages are independently applied are formed on the hologram plate 4 (for example, cells 4a and 4b). Since when the voltage is applied to each of the cells, an optical constant of liquid crystal sandwiched between the transparent electrodes facing each other changes, phases of light passing through the respective cells can be independently changed.

A memory 96 has stored therein information for controlling the hologram plate 4, which is associated with an image to be displayed. This control information is indicated by data which defines values of voltages to be applied to the regions. The data can be obtained by previously calculating a complex amplitude distribution resulting when an image composed of light points (the number of which is m) is displayed and by determining the voltages applied to the regions so as to allow the calculated complex amplitude distribution to be generated.

When the voltages are applied to the regions specified by the information which the controller 95 has read out from the memory 96, optical constants of the liquid crystal in the regions to which the voltages are applied change, and an optical grating is formed on the hologram plate 4. Accordingly, light L1 which is emitted from a light source and enters the hologram plate 4 is diffracted by the grating formed on the hologram plate 4 and is split into m rays D1, D2, . . . , and Dm. The rays split as D1, D2, . . . , and Dm are beamed at m light points P1, P2, and Pm, thereby forming the image.

Here, it is supposed that orthogonal coordinates on a surface of the hologram are defined as (x, y); complex amplitudes at the coordinates (x, y), resulting when the m light points P1, P2, . . . , and Pm are generated, are defined as u′1(x, y), u′2(x, y), . . . , and u′m(x, y), respectively; and a complex amplitude on the hologram plate 4 of the light L1 entering the hologram plate 4 is defined as u′0(x, y). In a case where a virtual mesh is assumed on the hologram plate 4 and the complex amplitudes are represented by values on intersection points of the mesh, representative values of the complex amplitude u′(x, y) in a given range are represented as u′(iΔ, jΔ) by using integer values i and j which can represent a whole area of the surface of the hologram and a mesh interval Δ. Accordingly, a complex amplitude U(iΔ, jΔ) of interfering light which is formed on the surface of the hologram by the rays beamed at the m light points and by the incident light 1 is obtained by using the following formula.

$$U ( i Δ , j Δ ) = {\sum }_{k = 0}^{m} {u}^{′} k ( iΔ , j Δ ) \qquad [ Formula 1 ]$$

Further, by using the following formula, the surface of the hologram can be partitioned to be regions A and B in accordance with a value of a real part of a complex number U(iΔ, jΔ). Note that in formulae 2 and 3, “Real( )” represents a real part of a complex number indicated between parentheses.

[Formula 2]

Real(U(iΔ, jΔ))≧0 (RegionA)

[Formula 3]

Real(U(iΔ, jΔ))< (Region B)

In the above-mentioned region A, a phase of the complex number U(iΔ, jΔ) is greater than or equal to −π/2 and less than or equal to π/2, and in the above-mentioned region B, a phase of the complex number U(iΔ, jΔ) is greater than π/2 and smaller than 3π/2. Since on the hologram plate 4, the regions A and B can be realized through applying or not applying voltages to the cells, a diffraction grating pattern on the hologram plate 4 can be represented approximately through binarization. According to this method, the diffraction grating pattern obtained by binarizing the complex amplitude distribution U of the light passing through the hologram plate 4 is used for the approximate reproduction, whereby the rays of diffraction light D1, D2, . . . , and Dm which are beamed at the m light points P1, P2, . . . , and Pm can be generated. However, since the diffraction grating is formed by using the approximate representation, a theoretical diffraction efficiency is low, approximately 40%.

In other words, it can be said that the above-described third method can be obtained by modifying the method of forming the hologram pattern according to the second method so as to use the formulae.

Non-patent document 1: “Applied Optical Electronics Handbook” published by SHOKODO CO., Ltd., on Apr. 10, 1989, P32

### DISCLOSURE OF THE INVENTION

### Problems to be Solved by the Invention

In recent years, utilization of a hologram for displaying and recording a moving image has been studied. In a case where the hologram is used in such an application, it is required that the number and positions of light points and light intensities can be changed in a real-time manner.

However, in the above-described third method, in a case where the number m of the lights points of which an image to be displayed is composed is large, there arises a problem that in order to calculate the complex amplitudes U(iΔ, jΔ) of the interfering light, an enormous amount of time is required. When it is considered that the time required for the calculation is limited, it is difficult in reality to calculate the complex amplitude distributions U of all of required patterns in the real-time manner.

Therefore, in order to change the number of the light points and the light intensities and to displace the light points in the real-time manner, it is required that complex amplitudes U(iΔ, jΔ) on all intersection points of a mesh with respect to all combinations of the number and positions of the light points and the light intensities at the respective light points are previously calculated and stored in the memory 6, and based on information read out from the memory 6 as necessary, voltages are applied to respective cells.

As one example, a case where the number of light points (including points before and after displacement), which is required for displaying, is 10,000 and there are 10 levels of light intensities at the respective light points, the 10 levels including a level at which an amount of light is zero (that is, a case where no rays of light is beamed at the light points), is assumed. In this case, the number of all patterns of complex amplitudes U (that is, the number of patterns in a state where the rays are beamed at the light points) is equal to the number of all the combinations of the number and positions of the light points and the light intensities at the respective light points and is astronomical, resulting in the 10,000th power of 10.

An amount of the data representing the complex amplitude distributions U of all of the required patterns can be calculated by multiplying the number of all of the above-mentioned patterns by an amount of information of the respective patterns. For example, in a case where a range of the values of i and j is −1000 through 1000 and the complex amplitudes U are represented through the binarization depending on whether the intersection points of the mesh belong to the region A or the region B, defining the complex amplitude distributions U of only one of the patterns requires information of 2001×2001 bits. Accordingly, even if the complex amplitude distributions U of all of the patterns can be obtained, an amount of data of all the obtained information is massive and cannot be stored in the memory 6 whose capacity is at the most approximately one terabyte.

In view of the above-described problem, an object of the present invention is to provide a hologram pattern generation method and a multiple light points generation apparatus which do not incur a massive increase in a required hardware resource and allow a hologram to be displayed while changing the number and positions of light points and light intensities in a real-time manner.

### Solution to the Problems

One aspect of the present invention relates to a hologram pattern generation method in which, by using a hologram element operable to change a diffraction grating pattern, rays of incident light entering the hologram element from a light source are beamed at m light points (m is a natural number less than or equal to n) selected from n points (n is a natural number) in a space, thereby forming an image.

In the hologram pattern generation method, a complex amplitude distribution of the rays of incident light on the hologram element and a complex amplitude distribution for collecting the rays of incident light at the n points respectively are previously prepared; a synthetic complex amplitude distribution on the hologram element is calculated through multiplying, by a value indicating a degree of an amplitude of each of the rays of incident light, the complex amplitude distribution of the rays of incident light and the complex amplitude distribution for collecting the rays of incident light at the m points, respectively and through calculating a sum of pieces of data, which are obtained by the multiplication, by performing addition; and the diffraction grating pattern on the hologram element is changed based on the calculated synthetic complex amplitude distribution.

In addition, another aspect of the present invention relates to a multiple light points generation apparatus operable to form an image by beaming rays of light at m light points (m is a natural number less than or equal to n) selected from n points (n is a natural number) in a space.

The multiple light points generation apparatus comprises: a hologram element allowing the rays of incident light from the light source to be diffracted and allowing a diffraction grating pattern of the rays of incident light to be changed; a memory having previously stored therein a complex amplitude distribution of the rays of incident light on the hologram element and a complex amplitude distribution for collecting the rays of incident light at the n points; and a controller controlling the hologram element such that a synthetic complex amplitude distribution on the hologram element is calculated through obtaining data by multiplying, by a value representing a degree of an amplitude of each of the rays of incident light, the complex amplitude distribution of the rays of incident light and the complex amplitude distribution for collecting the rays of incident light at the m points, respectively and through adding the data to the complex amplitude distribution of the rays of incident light and the complex amplitude distribution for collecting the rays of incident light at the m points, and the diffraction grating pattern on the hologram element is changed based on the calculated synthetic complex amplitude distribution.

By employing the above-described configuration, the complex amplitude distribution on the hologram element, which is required to generate a hologram pattern, can be obtained by the simple calculations and an amount of data of information which is required to be stored in the memory can be reduced to a minimum.

### Effect of the Invention

By employing a hologram pattern generation method and a multiple light points generation apparatus according to the present invention, even when an amount of information stored in a memory is small, it is made possible to beam rays of light at sufficiently many points and to change positions of light points and light intensities in a real-time manner.

### BRIEF DESCRIPTION OF THE DRAWINGS

FIG. 1 is a schematic diagram illustrating a configuration of a multiple light points generation apparatus according to Embodiment 1 of the present invention.

FIG. 2 is a flowchart showing a hologram pattern generation method performed by a controller shown in FIG. 1.

FIG. 3 is a schematic diagram illustrating a configuration of a multiple light points generation apparatus according to Embodiment 2 of the present invention.

FIG. 4 is a schematic diagram illustrating a configuration of a multiple light points generation apparatus according to Embodiment 3 of the present invention.

FIG. 5A is a plan view of a hologram plate shown in FIG. 4.

FIG. 5B is a side view of the hologram plate shown in FIG. 4.

FIG. 5C is an enlarged view of movable reflecting mirrors shown in FIG. 5B.

FIG. 6A is a schematic diagram illustrating a principle of recording a hologram by employing a first method.

FIG. 6B is a schematic diagram illustrating a principle of reproducing the hologram by employing the first method.

FIG. 7A is a schematic diagram illustrating a principle of recording a hologram according to a second method.

FIG. 7B is a schematic diagram illustrating a principle of reproducing the hologram according to the second method.

FIG. 8 is a schematic diagram illustrating a principle of reproducing a hologram according to a third method.

FIG. 9 is a schematic diagram illustrating a configuration of a hologram plate shown in FIG. 8.

### DESCRIPTION OF THE REFERENCE CHARACTERS

1 light source

4 hologram plate

5 controller

6 memory

8 collimator lens system

9 objective lens system

14 hologram plate

14D driving section

14M, 14N electrode plate

14R mirror element

### BEST MODE FOR CARRYING OUT THE INVENTION

### Embodiment 1

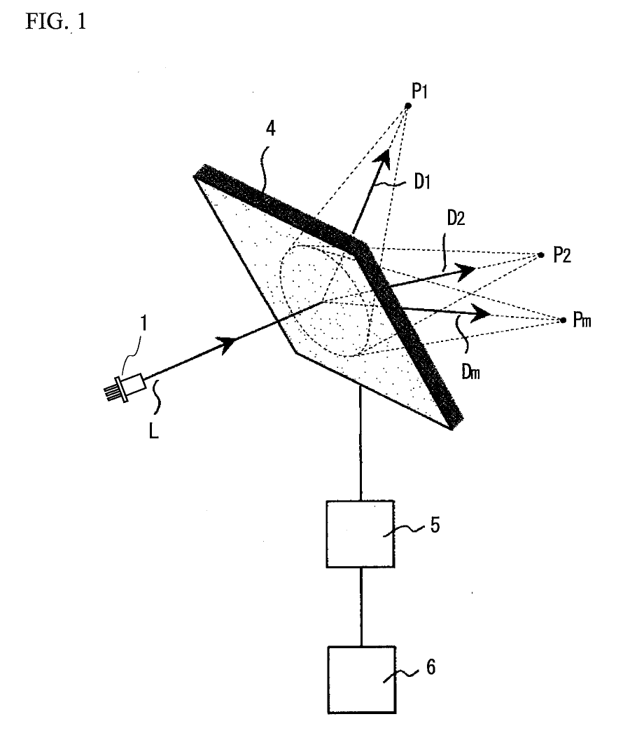

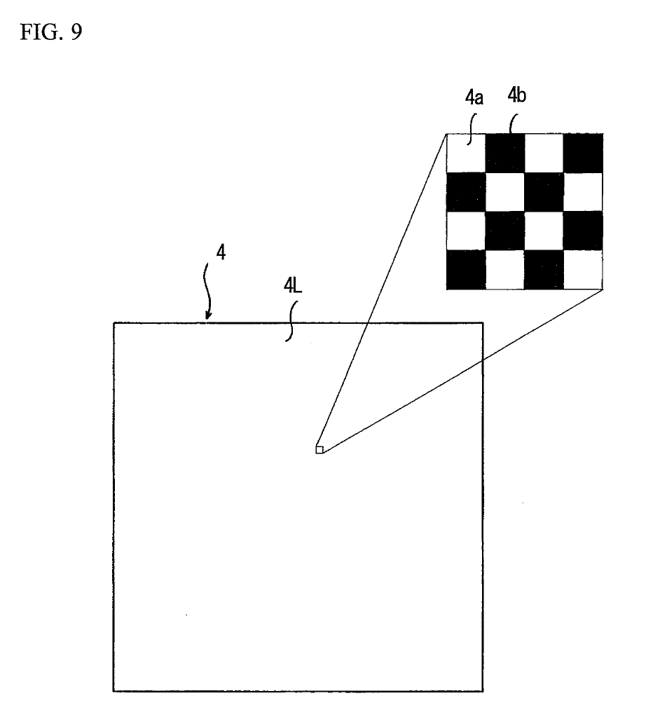

FIG. 1 is a schematic diagram illustrating a configuration of a multiple light points generation apparatus according to an embodiment 1 of the present invention. Since a basic configuration of a hologram plate 4 shown in FIG. 1 is the same as that shown in FIG. 9, the below descriptions will be given with reference to FIG. 9 as well as FIG. 1.

First, the basic configuration of the multiple light points generation apparatus according to the present invention will be described.

The multiple light points generation apparatus shown in FIG. 1 comprises: a light source 1; the hologram plate 4 capable of changing a diffraction grating pattern in accordance with control from outside; a controller 5 for controlling the hologram plate 4; and a memory 6 and forms an image by causing rays of light to be beamed at light points P1, P2, . . . , Pm (the number of which is m) which are selected from n points. Hereinafter, in order to facilitate understanding of the descriptions, each of the n points at which the hologram plate 4 can collect rays of light is referred to as “light collection point” and each of the m points, among the n points, used for forming the image is referred to as “display point”.

The hologram plate 4 includes a plurality of regions which independently change phases of rays of outgoing light with respect to phases of rays of incident light. The hologram plate 4 is an element which is capable of dynamically changing the diffraction grating pattern by changing a combination of phase conversion characteristics of each of the regions based on a control signal supplied from the controller 5.

In particular, as the hologram plate 4 of the present invention, a liquid crystal element which includes: a pair of electrodes facing each other; and a liquid crystal layer sandwiched between the electrodes is used. As described with reference to FIG. 9, whereas one transparent electrode (not shown) abutting the liquid crystal layer is integrally formed on a whole surface of the liquid crystal layer, the other transparent electrode includes a plurality of rectangular electrodes arranged in a checkerboard-like manner. As a result of this, in the hologram plate 4, a plurality of regions (hereinafter, referred to as “cells”) to which voltages are independently applied are formed (for example, the cells 4a and 4b in FIG. 9). Since when the voltage is applied to each of the cells, an optical constant of liquid crystal sandwiched between the transparent electrodes facing each other changes, phases of light passing through the respective cells can be independently changed.

The memory 6 has previously stored therein information indicating a complex amplitude distribution of incident light L on the hologram plate 4 and complex amplitude distributions on the hologram plate 4 in a case where rays of diffraction light are individually beamed at the n light collection points. These complex amplitude distributions, the number of which is n+1, have been previously obtained by calculations.

The controller 5 calculates the complex amplitude distributions on the hologram plate 4 based on the information of the complex amplitude distributions, which have been stored in the memory 6, and the information for determining the m display points of which an image to be displayed is composed. It is only required for the information for determining the display points to include data from which coordinates of the points to be displayed and emission intensities (amplitudes) at the points to be displayed can be determined. This information for determining the display points may be stored in the memory 6 or supplied from outside. Further, the controller 5 generates control signals for driving the respective cells of the hologram plate 4 based on the calculated complex amplitude distributions and supplies the generated control signals to the hologram plate 4. Although a configuration of the controller 5 is not particularly limited, the controller 5 can be realized, typically, as a general-purpose or dedicated computer having an arithmetic unit such a CPU.

The data stored in the memory 6 and details of processing performed by the controller 5 will be described later.

When the voltages are applied to the respective cells in accordance with the control signals supplied from the controller 5, optical constants of the respective cells change in accordance with the applied voltages, whereby an optical grating (or a hologram) is formed on the hologram plate 4. When light L emitted from the light source enters the hologram plate 4, the light L is diffracted by the formed grating and split into m rays, D1, D2, . . . , and Dm. The split rays D1, D2, . . . , and Dm are beamed at the m display points P1, P2, and Pm, thereby forming the image to be displayed.

Next, details of the hologram pattern generation method performed by the controller 5 will be described.

In the below descriptions, (x, y) are supposed to be orthogonal coordinates on a surface of the hologram; a total number of the light collection points (including points before and after displacement) is supposed to be n; a complex amplitude on the coordinates (x, y) in a case where the light is beamed at only one light collection point Pk (k is an integer greater than or equal to 1 and less than or equal to n) is supposed to be uk(x, y); and a complex amplitude at the coordinates (x, y) of the light L incident on the hologram plate 4 is supposed to be u0(x, y).

Here, in order to facilitate representation of the complex amplitude distributions, a virtual mesh is assumed on the surface of the hologram, and a complex amplitude distribution in a region of a certain coordinate range (a range of the x and y coordinates) is represented by a value of a complex amplitude on an intersection point of the mesh. A mesh spacing is represented by Δ, i and j are any integers (note that i and j are integers of magnitudes which allow a whole area of the surface of the hologram to be represented), and a complex amplitude on an intersection point of the mesh in the case where the light is beamed at only the one light collection point Pk is represented as uk(iΔ, jΔ).

In this case, a complex amplitude distribution on the hologram plate 4 in a case where light having a predetermined amplitude (hereinafter, referred to as a “reference amplitude”) is beamed at only the one light collection point Pk can be represented as a set of a plurality (that is, the number of combinations of i and j) of complex amplitudes uk(iΔ, jΔ). Similarly, a complex amplitude distribution on the hologram plate 4 in a case where the incident light L having the reference amplitude enters the hologram plate 4 can be represented as a set of a plurality (that is, the number of combinations of i and j) of complex amplitudes u0(iΔ, jΔ).

Hereinafter, in order to facilitate understanding of the descriptions, a distribution of the complex amplitudes u0(iΔ, jΔ) on the whole hologram plate 4, resulting when the incident light L having the reference amplitude enters the hologram plate 4, is denoted simply as “u0”, and a distribution of the complex amplitudes uk(iΔ, jΔ) on the whole hologram plate 4, resulting when the incident light having the reference amplitude is beamed at only the light collection point Pk, is denoted simply as “uk”.

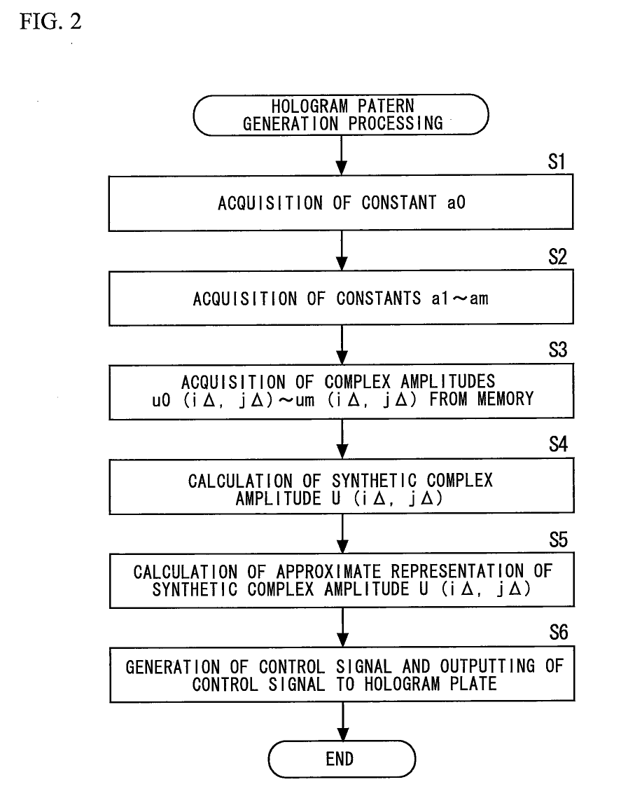

FIG. 2 is a flowchart showing the hologram pattern generation method performed by the controller 5 shown in FIG. 1. Here, an example in which incident light L having an amplitude which is a0 times the reference amplitude is inputted to the hologram plate 4 and rays having optical amplitudes (intensities are the second power thereof) which are al times, a2 times, . . . , and am times the basic amplitude are beamed at any m display points P1, P2, and Pm, selected from the n light collection points will be described.

At step S1, the controller 5 acquires a constant a0 indicating a degree of an amplitude of the incident light L. The constant a0 may be previously stored in the memory 6 or may be inputted from outside.

At step S2, the controller 5 acquires constants a1, a2, . . . , and am indicating degrees of the optical amplitudes of the rays beamed at the m display points of which the image to be displayed is composed. As similarly to the constant a0, the constants a1, a2, . . . , and am may be previously stored in the memory 6 or may be inputted from outside.

At step S3, the controller 5 reads out, from the memory 6, the complex amplitudes u0(iΔ, jΔ) of the incident light L and complex amplitudes u1(iΔ, jΔ), u2(iΔ, jΔ), . . . , and um(iΔ, jΔ) which respectively correspond to the m points.

At step S4, based on the constants a0, a1, . . . , and am acquired at steps S1 and S2 and on the complex amplitudes u1(iΔ, jΔ), u2(iΔ, jΔ), . . . , and um(iΔ, jΔ) acquired at step S3, the controller 5 synthesizes complex amplitudes (values to which multiples of the amplitudes of the respective rays are multiplied) generated by beaming the rays of the incident light L at all of the display points and obtains a synthetic complex amplitude U(iΔ, jΔ) to be generated on the hologram plate 4. Specifically, the synthetic complex amplitude U(iΔ, jΔ) can be obtained by using the following formula.

$$U ( iΔ , j Δ ) = {{\sum }_{k = 0}}^{m} ak * uk ( i Δ , j Δ ) \qquad [ Formula 4 ]$$

At step S5, based on whether or not a real part (which may be an imaginary part) of the calculated synthetic complex amplitude U(iΔ, jΔ) is greater than or equal to a predetermined threshold value, the controller 5 binarizes the synthetic complex amplitude U(iΔ, jΔ) and obtains approximate representation of each of the synthetic complex amplitude U. For example, in a case where “0” is adopted as the threshold value, in accordance with the formulae 2 and 3 explained in the above-described “BACKGROUND ART”, a value of the real part of the synthetic complex amplitude U(iΔ, jΔ), which is represented as a complex number, and the threshold value are compared. Based on this comparison result, each of the regions (cells) on the hologram plate 4 can be partitioned to be a region A in which a phase of an outgoing ray is greater than or equal to −π/2 and less than or equal to π/2 and to be a region B in which a phase thereof is greater than π/2 and less than 3π/2. In a case where the synthetic complex amplitude U(iΔ, jΔ) are expressed in binary, it is only required to represent phases of rays of outgoing light from the regions A and B by “0” and “π”, respectively (a difference between the phases is “π”).

A purpose of this step S5 at which the binarization is performed is to simplify controlling of the respective cells to an extent that the diffraction grating patterns which correspond to a calculated synthetic complex amplitude distribution U can be configured on the hologram plate 4 in reality. Accordingly, in a case where an element which can control in a further minute manner the phases of the rays of the outgoing light from the respective cells is used as the hologram plate 4, the synthetic complex amplitude U(iΔ, jΔ) may be approximated by multiple values of three or more true values.

The controller 5 calculates the synthetic complex amplitudes U(iΔ, jΔ) with respect to all of the intersection points of the mesh, which are set on the hologram plate 4, and obtains the synthetic complex amplitude distribution U on the hologram plate 4.

At step S6, based on the calculated synthetic complex amplitude distribution U, the controller 5 generates signals for controlling phase conversion characteristics of the respective cells and supplies the generated control signals to the hologram plate 4. More specifically, the controller 5 controls voltages supplied to the cells which correspond to the intersection points of the mesh (iΔ, jΔ) such that the phases of the rays of the outgoing light from the region A become “0” and the phases of the rays of the outgoing light from the region B become “π”.

As a result of this, a diffraction grating pattern which corresponds to the approximate representation of synthetic complex amplitude distribution U (that is, the binarized synthetic complex amplitude distribution U) obtained at step S5 is configured on the hologram plate 4. Accordingly, the rays of the light emitted from the light source are diffracted by the diffraction grating on the hologram plate 4 and converted to rays of diffraction light D1, D2, . . . , and Dm. The rays of diffraction light D1, D2, . . . , and Dm are beamed at the m display points P1, P2, . . . , and Pm, thereby forming the image. Since the diffraction grating is formed by using the approximate representation, a theoretical diffraction efficiency is low, approximately 40%. When the synthetic complex amplitude U(iΔ, jΔ) can be approximated by the multiple values of three or more digits, the diffraction efficiency can be further increased.

Here, a capacity of the memory 6, which is required in the hologram pattern generation method according to the present embodiment, will be evaluated.

As similarly to in the conventional example, a total number of light points (including points before and after displacement) is supposed to be 10,000 and a range of values of i and j is supposed to be −1000 through 1000. First, in the method according to the present invention, the number of data sets of complex amplitude distributions uk with distribution data of rays of incident light L added, previously stored in the memory 6, is 10000+1. Since regions on the hologram plate 4 are represented by 2001×2001 intersection points of the mesh, in a case where the complex amplitude uk(iΔ, jΔ) on the respective intersection points of the mesh is expressed in binary (1 bit), a data amount of the complex amplitude distribution uk is 2001×2001 bits.

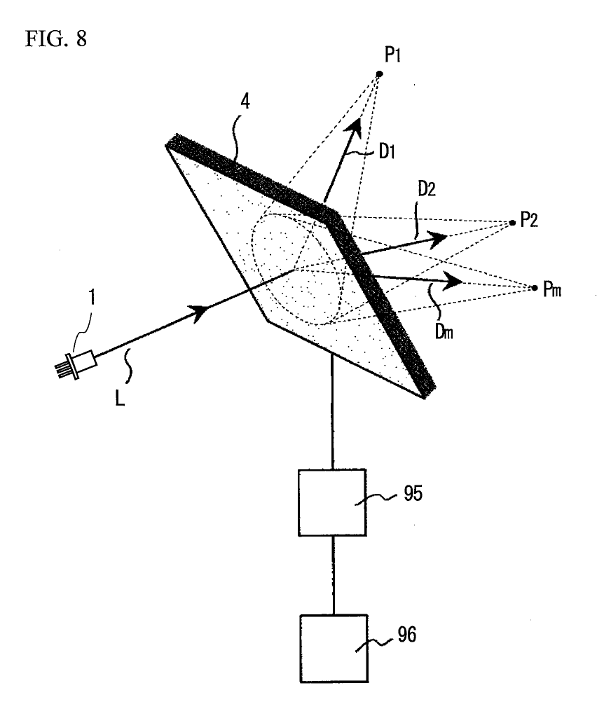

Therefore, a data amount of the complex amplitude distributions u0 through un, which should be prepared when the rays of incident light L are beamed at the n light collection points, is calculated by multiplying 10001 as the number of data sets by 2001×2001 bits as the data amount of the data sets and is obtained as approximately 4.0×1010 bits. In the present invention, since the amplitudes (light intensities) of the rays of the incident light and the beamed rays are taken into consideration through multiplying the amplitudes by the constants a0 through an, it is not needed to previously prepare data in which the amplitudes (intensities) of the rays of the incident light and the beamed rays are reflected. Accordingly, as compared with the third method described with reference to FIG. 8, the data amount is reduced to be small. Since the data of the above-mentioned amount in this example can be all stored in the memory 6 having a capacity of 5 GB, it can be said that the capacity of the memory is practical.

The synthetic complex amplitude distribution U for configuring the diffraction grating pattern can be obtained by reading out the complex amplitudes uk(iΔ, jΔ) from the memory 6 and by performing the arithmetic processing (Formula 4) in which the read-out values are multiplied by the constants ak, respectively and a sum of all of the obtained values is calculated through addition. A size of the data of the complex amplitudes uk(iΔ, jΔ), previously stored in the memory 6, is small, and reading out the data can be completed for a short period of time. In addition, since only simple multiplication and addition are performed in the arithmetic processing performed by the controller 5, even a CPU having a current capability can complete the arithmetic processing in a short period of time.

As described above, in the method according to the present invention, even in a case where the number and positions of the light collection points and the intensities of the light collection points are changed, the synthetic complex amplitude distribution U on the hologram plate 4, which is required to generate the hologram pattern, can be calculated for the short period of time by using the fixed amount of the data stored in the memory 6. Thus, according to the present invention, it is made possible to generate the hologram pattern in a real-time manner without requiring drastic enhancement of performance of a hardware resource and without incurring an increase in the hardware resource.

In particular, in the above-described method, since the intensities (amplitudes) of the respective rays (the rays of the incident light and the beamed rays) are reflected by multiplying the previously prepared complex amplitudes by the constants a0 through am, flexibly and easily changing the light intensities (amplitudes) of the light source 1 and the display points is enabled.

### Embodiment 2

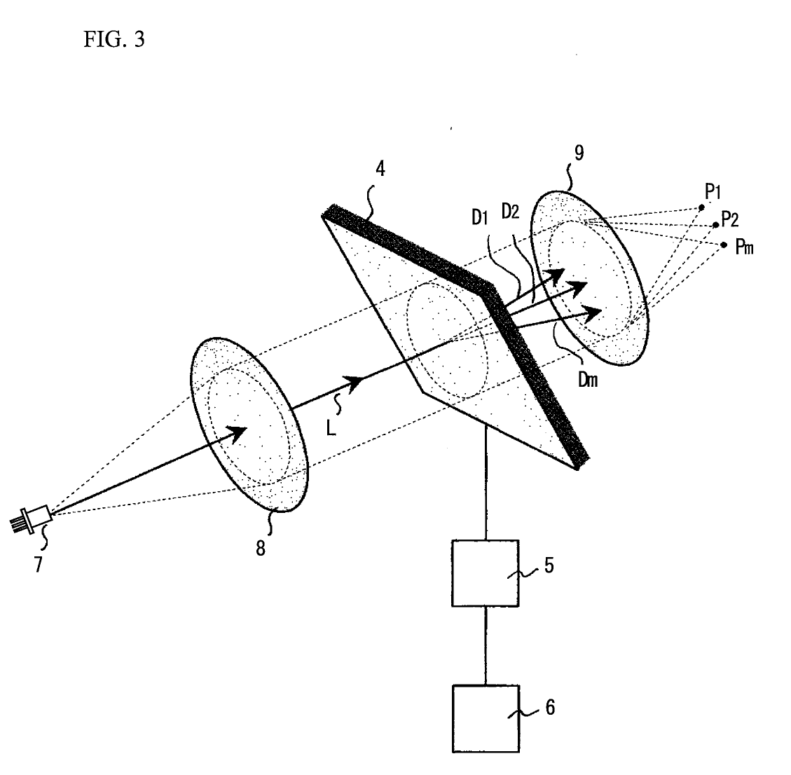

FIG. 3 is a schematic diagram illustrating a configuration of a multiple light points generation apparatus according to an embodiment 2 of the present invention. Since a basic configuration of the multiple light points generation apparatus according to the present embodiment is the same as that according to the embodiment 1, differences between the embodiments 1 and 2 will be mainly described.

The multiple light points generation apparatus shown in FIG. 3 is provided with a light source 7 which emits rays of diverging light, instead of the light source 1. In addition, further provided are a collimator lens system 8 which converts the rays of diverging light, emitted from the light source, to substantially parallel rays and transmits the converted substantially parallel rays toward a hologram plate 4; and an objective lens system 9 which collects rays outgoing from the hologram plate 4.

Since the configurations of the hologram plate 4, the controller 5, and the memory 6, and the methods of generating the data and the hologram pattern are the same as those in the embodiment 1, repetitive descriptions thereof will be omitted.

In the present embodiment, the rays outgoing from the hologram plate 4 can be converged by the objective lens system 9. Therefore, when intervals among the display points P1 through Pm are constant, a diffraction angle of each of the rays of diffraction light can be made smaller than that in the embodiment 1. Accordingly, in a case where an image having the same definition level as that in the embodiment 1 is displayed, a hologram element in which intervals among the regions (cells) are greater than those in the embodiment 1 can be used, thereby bringing about an advantage that representation of a complex amplitude distribution U is rough.

### Embodiment 3

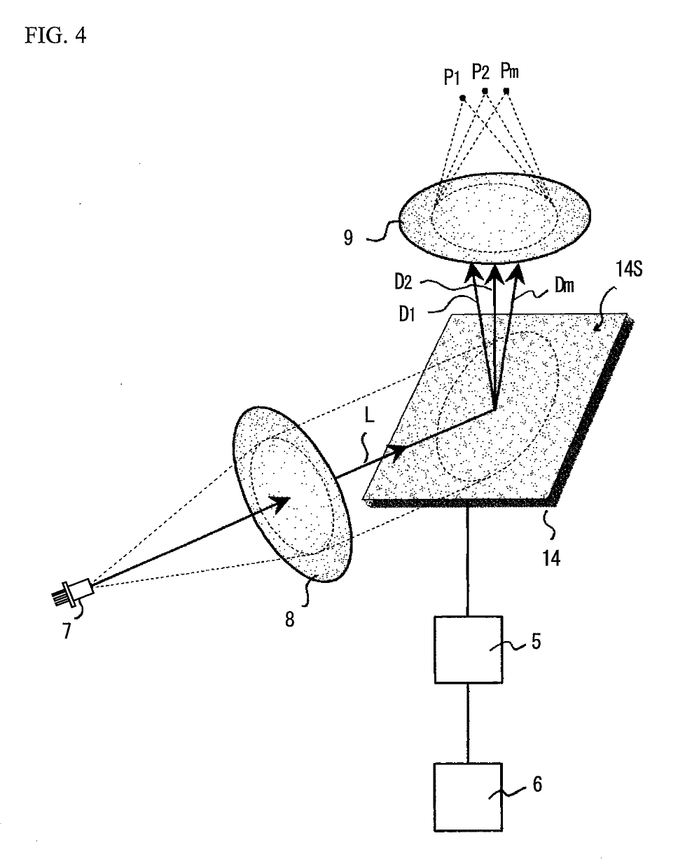

FIG. 4 is a schematic diagram illustrating a configuration of a multiple light points generation apparatus according to an embodiment 3 of the present invention.

Although a basic configuration of the multiple light points generation apparatus according to the embodiment 3 is the same as that according to the embodiment 2, the present embodiment is different from the embodiment 3 in that a hologram plate 14 which is light-reflection-type is provided, instead of the hologram plate 4 which is light-transmission-type. Hereinafter, differences between the embodiments 2 and 3 will be mainly described.

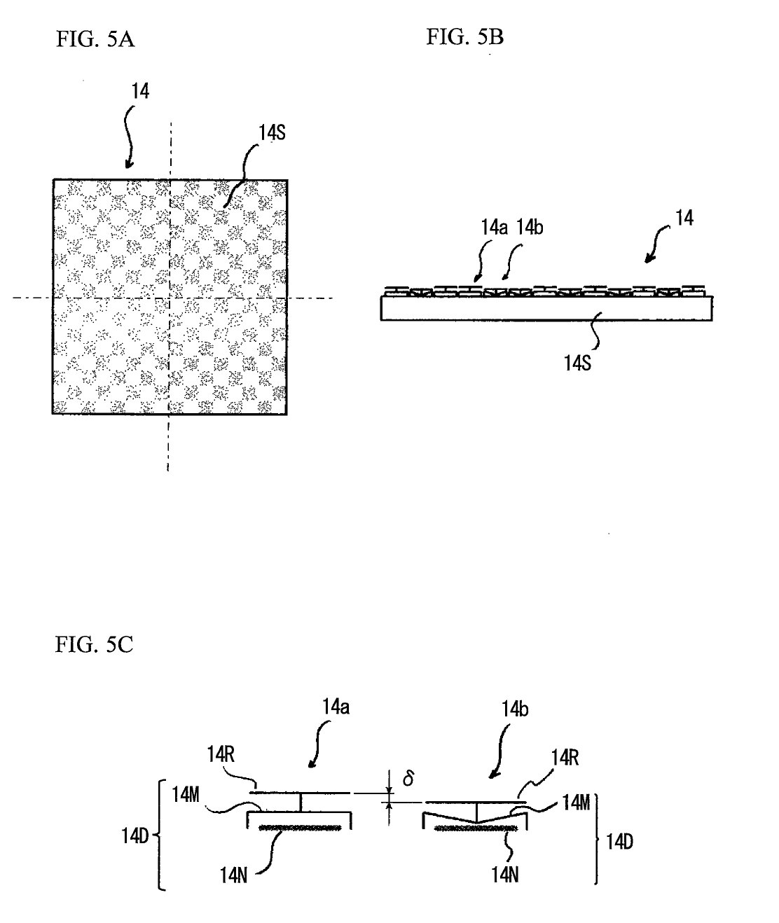

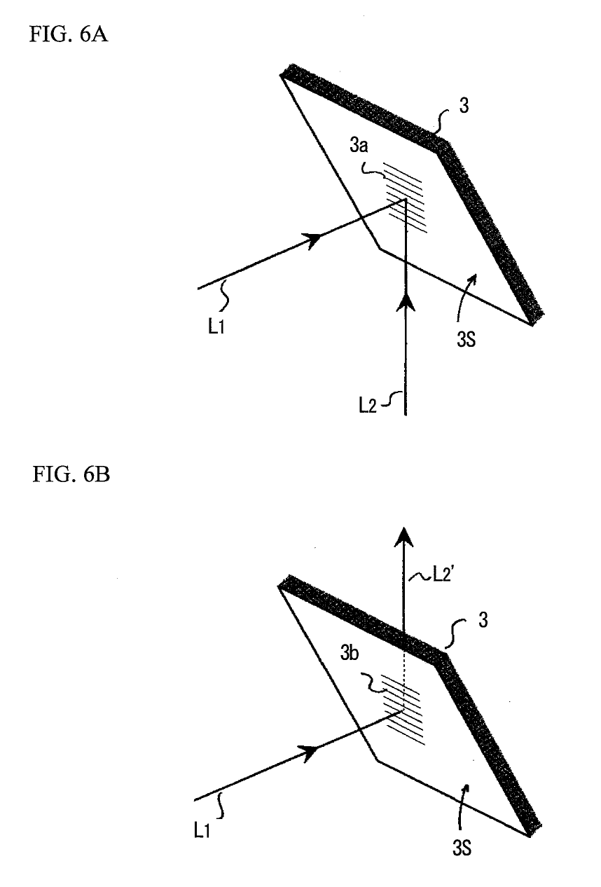

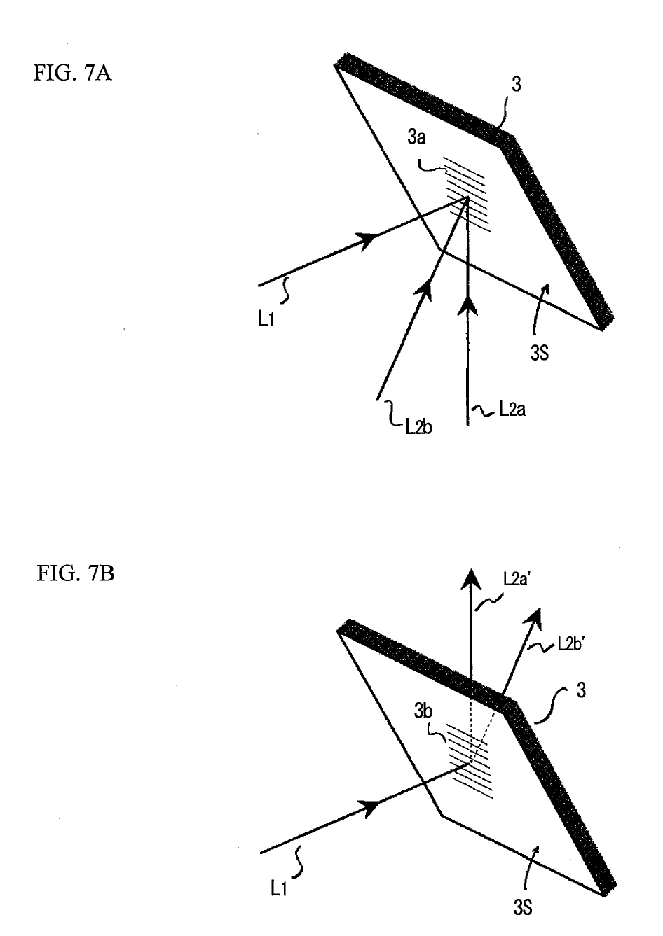

FIG. 5A and FIG. 5B are a plan view and a side view of the hologram plate 14 shown in FIG. 4, respectively. FIG. 5C is an enlarged view of movable reflecting mirrors 14a and 14b shown in FIG. 5B.

As shown in FIG. 5A, 5B, and 5C, on a substrate 14S of the hologram plate 14, a plurality of movable reflecting mirrors 14a and 14b which are rectangular and arranged in a checkerboard-like manner are provided. Each of the movable reflecting mirrors 14a and 14b includes a mirror element 14R and a driving section 14D which moves the mirror element 14R in a direction perpendicular to a reflecting surface thereof (a direction perpendicular to a plane of paper of FIG. 5A). Each of the movable reflecting mirrors 14a and 14b changes a position of the mirror element 14R in accordance with a control signal supplied from the controller 5, thereby spatially modulating, in an independent manner, a phase of incident light by which each region is irradiated.

More specifically, as shown in FIG. 5C, the driving section 14D includes an electrode plate 14M fixed on a surface of the substrate 14S and an electrode plate 14N which is deformable, placed so as to face the electrode plate 14M, and connected to the mirror element 14R. When based on the control signal supplied from the controller 5, electric charges are applied between the electrode plates 14M and 14N, the Coulomb force in accordance with an amount of the applied electric charges is generated between the electrode plates 14M and 14N and therefore, a relative spacing between the electrode plates 14M and 14N is changed, thereby moving the mirror element 14R, connected to the electrode plate 14N, in the direction perpendicular to the reflecting surface of the mirror element 14R.

When the electric charges are applied to both of the electrode plates 14M and 14N with polarities of the electric charges applied to the electrode plate 14M and the electric charges applied to the electrode plate 14N being opposite to each other (the movable reflecting mirror 14b), the electrode plate 14N is attracted by the electrode plate 14M and bows, thereby moving the mirror element 14R to a side of the substrate 14S. In other words, a level of the mirror element 14R, attained when the electric charges having the opposite polarities are applied to both of the electrode plates 14M and 14N (the movable reflecting mirror 14a), can be shifted by δ with respect to a level of the mirror element 14R, attained when the electric charges having the same polarity are applied to both of the electrode plates 14M and 14N (the movable reflecting mirror 14a). Here, supposing that an angle formed by an incident light axis and a normal of the reflecting surface of the mirror element 14R is θ, when δ is cos θ times or more as long as a wave length of the light from the light source 1, a phase of the reflecting light can be controlled to be any value in a range of −π through +π due to a shift amount (±δ) of the mirror element 14R.

In the present embodiment, although the reflection-type hologram plate 14 is used instead of the transmission-type hologram plate 4, information stored in the memory 6 and a method of calculating the complex amplitude distribution U by using the controller 5 are the same as those in the embodiments 1 and 2. Based on the approximate representation of the calculated complex amplitude distribution U, the controller 5 generates a control signal for controlling a shift amount of each of the mirror elements 14R (that is, a polarity and an amount of the electric charges to be applied to each of the electrodes 14M and 14N) and supplies the control signal to the hologram plate 14. As a result of this, as similarly to in the embodiments 1 and 2, the diffraction grating pattern on the hologram plate 14 can be changed in a real-time manner.

In the present embodiment, although the collimator lens system 8 and the objective lens system 9 are used, these lens systems may be omitted.

As described above, as similarly to in the embodiments 1 and 2, the multiple light points generation apparatus according to the present embodiment enables the hologram pattern of the diffraction grating pattern on the hologram plate 14 to be generated in the real-time manner without incurring a drastic increase in a hardware resource. In general, since the hologram plate 14 utilizing the Coulomb force in accordance with the amount of the electric charges is better in responsiveness than that of the hologram plate 4 using the liquid crystal, the multiple light points generation apparatus according to the present embodiment further attains an advantage in terms of adaptability at high frequencies, as compared with those according to the embodiments 1 and 2.

Although in each of the above-described embodiments, the example in which “0” is used as the threshold value for binarizing the complex amplitudes is described, a value other than “0”, which allows a diffraction grating pattern generating appropriate diffraction light to be obtained, may be used as the threshold value.

In addition, the above-described hologram pattern generation method can be applied to a multiple light points generation apparatus for forming a color image. In this case, it is only required that as the light source 7, a light source which is capable of emitting rays having a plurality of wave lengths (for example, R, G, B) is used and as the information for determining the points to be displayed, information indicating which points correspond to which colors, respectively (for example, R, G, B) is further included.

Furthermore, the above-described hologram pattern generation method can be realized as a program for causing a computer to execute the above-described processing procedure stored in a memory or a storage medium (a ROM, a RAM, a hard disc, etc.).

The controller in each of the embodiments may be realized as an LSI which is an integrated circuit. In addition, an FPGA (Field Programmable Gate Array), which is an LSI that can be programmed after manufacture, or a reconfigurable processor enabling connections and settings of the circuit cells in the LSI to be reconfigured may be used.

Moreover, although in the embodiments 2 and 3, the collimator lens system 8 and the objective lens system 9 are used, the numbers of elements configuring these lens systems are not particularly limited and may be any numbers.

### INDUSTRIAL APPLICABILITY

A hologram pattern generation method and a multiple light points generation apparatus according to the present invention are applicable to an apparatus in which instantaneousness in generating and changing of a hologram pattern is required, for example, as in a display apparatus or a storage device.

1. A hologram pattern generation method for generating a hologram pattern to form an image, by using a hologram element operable to change a diffraction grating pattern and by beaming rays of incident light entering the hologram element from a light source at m light points (m is a natural number less than or equal to n) selected from n points (n is a natural number) in a space, comprising:
preparing a complex amplitude distribution of the rays of incident light on the hologram element and complex amplitude distributions for collecting the rays of incident light at the n points respectively,
calculating a synthetic complex amplitude distribution on the hologram element through multiplying, by a value indicating a degree of an amplitude of each of the rays of incident light, the complex amplitude distribution of the rays of incident light and the complex amplitude distribution for collecting the rays of incident light at the m points, respectively and through calculating a sum of pieces of data, which are obtained by the multiplication, by performing addition, and
changing the diffraction grating pattern on the hologram element based on the calculated synthetic complex amplitude distribution.

2. The hologram pattern generation method according to claim 1, wherein
the diffraction grating pattern includes a plurality of regions, each of which changes a phase of each ray of outgoing light from a phase of each of the rays of incident light in an independent manner based on a control signal supplied, and
said changing of the diffraction grating pattern includes:
obtaining approximate representation of the synthetic complex amplitude distribution by, based on the calculated synthetic complex amplitude, representing in binary a first region in which a real part of each complex amplitude is greater than or equal to a predetermined threshold value and a second region in which a real part of each complex amplitude distribution is less than the threshold value, and
controlling phase conversion characteristics attained by the respective regions based on the approximate representation of the synthetic complex amplitude distribution.

3. The hologram pattern generation method according to claim 2, wherein
said changing of the diffraction grating pattern includes displacing the phase of each of the rays of light outgoing from the second region by π with respect to the phase of each of the rays of light outgoing from the first region.

4. A multiple light points generation apparatus operable to form an image by beaming rays of incident light entering a hologram element from a light source at m light points (m is a natural number less than or equal to n) selected from n points (n is a natural number) in a space, comprising:
a light source;
the hologram element for diffracting the rays of incident light from the light source and for changing a diffraction grating pattern thereon;
a memory for storing a complex amplitude distribution of the rays of incident light on the hologram element and complex amplitude distributions for collecting the rays of incident light at the n points; and
a controller for calculating a synthetic complex amplitude distribution on the hologram element through multiplying, by a value indicating a degree of an amplitude of each of the rays of incident light, the complex amplitude distribution of the rays of incident light and the complex amplitude distributions for collecting the rays of incident light at the m points, respectively and through calculating a sum of pieces of data, which are obtained by the multiplication, by performing addition, and for controlling the hologram element such that the diffraction grating pattern is changed based on the calculated synthetic complex amplitude distribution.

5. The multiple light points generation apparatus according to claim 4, wherein
the diffraction grating pattern includes a plurality of regions, each of which changes a phase of each ray of outgoing light from a phase of each of the rays of incident light in an independent manner based on a control signal supplied, and
the controller obtains approximate representation of the synthetic complex amplitude distribution by, based on the calculated synthetic complex amplitude, representing in binary a first region in which a real part of each complex amplitude is greater than or equal to a predetermined threshold value and a second region in which a real part of each complex amplitude distribution is less than the threshold value and controls phase conversion attained by the respective regions based on the approximate representation of the synthetic complex amplitude distribution.

6. The multiple light points generation apparatus according to claim 5, wherein
the hologram element includes a liquid crystal element allowing an optical constant of each of the regions to be changed, and
the controller controls the optical constant of each of the regions such that the phase of each of the rays of light outgoing from the second region is displaced by π with respect to the phase of each of the rays of light outgoing from the first region.

7. The multiple light points generation apparatus according to claim 5, wherein
the hologram element includes:
a plurality of mirror elements placed on surfaces of the regions; and
a plurality of driving sections for shifting, based on a control signal supplied, the mirror elements in a direction perpendicular to a reflecting surface of each of the mirror elements, and
the controller controls an amount, in which each of the mirror elements is shifted by each of the plurality of driving sections, such that a phase of each ray of light outgoing from the second region is displaced by π with respect to a phase of each ray of light outgoing from the first region.

8. The multiple light points generation apparatus according to claim 4, further comprising:
a first lens system for converting rays of diverging light, emitted from the light source, to substantially parallel rays; and
a second lens system for collecting rays outgoing from the hologram plate.
